(19) United States
(12) Patent Application Publication
(10) Pub. No.: US 2005/0035196 A1
(43) Pub. Date: Feb. 17, 2005

(54) Autograph card tracking and verification

(76) Inventors: Winston Chandler Whitmarsh, Los Angeles, CA (US); Michelle Arnsdorf Fie, Oakland, CA (US)

Correspondence Address: Sharon J. Adams, #230, 1867 Ygnacio Valley Rd., Walnut Creek, CA, 94598, US

(21) Appl. No.: 10/641,936

(22) Filed: Aug. 15, 2003

(51) Int. Cl. G06K 5/00

(52) U.S. Cl. 235/380

(57) ABSTRACT

A process for tracking and verifying cards with original autographs. The process includes obtaining cards where each card contains a unique tracking number and a security feature; delivering the cards to a specific location; retaining a record of the unique tracking numbers and the specific location where the cards containing the unique tracking numbers were shipped; determining which cards containing the unique tracking numbers arrived at the specific location; and maintaining a database containing a corrupt card list and a valid card list.

### CROSS REFERENCE TO RELATED APPLICATIONS

Not Applicable.

### FEDERAL SPONSORSHIP

Not Applicable.

### BACKGROUND OF THE INVENTION

The practice of signing autographs, commonly used by individuals who have attained an arbitrary degree of fame or notoriety (referred to here as celebrities), is a time-honored and popular practice. This practice is widely recognized throughout much of the United States and the rest of the world and is commonly associated with celebrities.

The act of signing an autograph is, in most cases for most celebrities, a relatively simple act of placing a writing instrument to a surface that may be written on and signing the celebrity's name. But what happens to the resultant physical autographs has evolved into a very large and complex autograph industry. This industry encompasses the obtaining of autographs, the hobby of collecting autographs or autographed items, and the multiple forms of businesses that sell autographs or autographed items.

The autograph industry is unique in requiring a physical signature, and authentication to verify that the autographed item is not forged. The autograph industry currently suffers from a number of disadvantages in both obtaining the original celebrity signatures, and in verifying that autographs are authentic.

Many difficulties may be encountered in obtaining original signatures. Celebrities may wish to please many fans by giving autographs. However, celebrities are often limited in the amount of time the celebrity can spend signing autographs for fans. The celebrity may lack the ability to sign a large number of autographs at one time, location, or event; the celebrity may lack of an adequate item upon which to place his or her signature; the celebrity may lack the space needed to write the signature; the celebrity may be presented with an item to autograph that the celebrity may not wish to autograph; or there may be security issues that prevent the celebrity from signing autographs.

There are additional difficulties after the celebrity signs the autographed item. The autograph industry is rampant with forgeries. By some estimates, up to 80% of all autographed items are fakes. With the advent in recent years of better and better electronic methods of duplication, the capabilities have increased exponentially for those wishing to produce and sell authentic looking forged autographs.

As a direct result of the common practice of creating forged autographs many celebrities do not sign autographs, or sign autographs in ways they think may help curtail said fraudulent activity, or sign autographs but are displeased with the fact that said fraudulent activity routinely occurs.

Once an item has been autographed, and leaves the possession of the celebrity it becomes difficult to trace the ownership of the autographed item. Therefore, it is often difficult to verify that the celebrity signature is authentic. Because of this, many individuals who purchase autographed items are left with no choice but to take it on good faith that the autographs on the autographed items they are purchasing are in fact authentic. In addition, the person selling the autograph may have to provide personal verification that the signature if authentic, potentially exposing the person to liability if the verification is incorrect.

The prior art includes many methods by which a celebrity signs a labeled autograph item in front of the fan or other witness. The label allows the fan or other witness to then track the autographed item to verify authenticity. For example, International Patent No. WO 01/57761 A1, issued to Fredrick Noyes on Aug. 9, 2001 describes an autograph verification and authentication process. In this process, the celebrity meets with a direct representative of the provider of the verification system. This process requires that the celebrity sign the autographed item in the presence of the provider representative. The representative places a unique, tamper-proof label on the autographed item to verify authenticity of the autograph. This method requires that the representative and celebrity make a specific appointment to complete the authentication process.

Likewise, U.S. Pat. No. 5,971,435 issued to Robert D. DiCesare on Oct. 26, 1999 requires that the autographed item be signed in the presence of the consumer and a representative of the authentication company. The consumer and representative sign a voucher containing a code number, and labeling the autographed item with the same code number.

U.S. Patent Application No. US2002/0133703 A1, published on Sep. 19, 2002, listing the inventor as Dan C. Morgan, requires the celebrity to sign the autographed item in the presence of the consumer. The consumer then accesses an on-line database and provides the information to authenticate the autograph. Of course, this invention suffers from the problem that there is no independent verification of the consumer's information. The consumer may not tell the truth when entering information into the on-line database. Likewise, other inventions, such as U.S. Pat. No. 6,142,532, issued to Gluck on Nov. 7, 2000 and U.S. Pat. No. 6,082,774 issued to Schlauch on Jul. 4, 2000 lack independent verification of the celebrity autograph.

### SUMMARY OF THE INVENTION

The present invention allows a celebrity to sign autograph cards containing a unique tracking number at his or her leisure and then transfer said autographs into the public domain. Once the signed autographs are in the public domain the authenticity of the autographs may be verified by the tracking number.

The autograph cards will contain one or more security features to deter or prevent unauthorized duplication. The security features could include, but are not limited to, a hologram, a printed number in small type behind the hologram, gradated dot pattern type, security type, a gradated drop shadow frame, and other printed security features. The cards will also contain a tracking number that is unique to each card.

The pre-numbered cards are delivered to a specific location determined by the celebrity or the celebrity representative. The cards are delivered to the proper person at the proper location. All numbered cards will be accounted for. Any cards that are lost or stolen will be identified in a database or an on-line web site.

After the cards are delivered to the specific location, the celebrity can sign the cards at his or her convenience. There is no need to have any witness or provider representative present during the signing.

The celebrity can then personally distribute the pre-signed autographed cards at any time. The pre-signed cards may also be distributed by authorized celebrity representatives at concerts, movie premiers, or other venues. Alternatively, if the celebrity wants to sign the autograph card in the presence of the fan the celebrity can do so.

Once the pre-numbered cards have been delivered to the celebrity and have been autographed, the authenticity of the signatures will be verified through a database or on-line account. The database will contain the number of each card and the status of each numbered card.

Another embodiment of the cards will allow a celebrity to distribute a card with the celebrity's printed (rather than original) signature. Although these cards will not have an original signature, the celebrity will officially authorize them. These pre-signed cards may also be tracked and verified.

The present invention will make it easier and more convenient for a celebrity to create and transfer autographs into the public domain. Once an autograph card is in the public domain, the consumer will be able to track the card to verify its authenticity.

### DESCRIPTION OF THE DRAWINGS

FIG. 1 is a view of the obverse side of an embodiment of the invention.

FIG. 2 is a view of the obverse side of an embodiment of the invention.

FIG. 2a is an enlarged view of one of the security features shown in FIG. 2.

FIG. 3 is view of the reverse side of an embodiment of the invention.

FIG. 3a is an enlarged view of one of the security features shown in FIG. 3.

FIG. 4 is a view of the obverse side of an embodiment of the invention.

FIG. 5 is a view of the obverse side of an embodiment of the invention.

FIG. 6 is a view of the obverse side of an embodiment of the invention.

FIG. 7 is a view of the obverse side of an embodiment of the invention.

FIG. 8 is a flowchart representation of the primary steps of the invention.

FIG. 9 is a view of the obverse side of an embodiment of the invention.

FIG. 10a is a view of the obverse side of an embodiment of the invention.

FIG. 10b is a view of the obverse side of an embodiment of the invention.

FIG. 10c is a view of the obverse side of an embodiment of the invention.

FIG. 10d is a view of the obverse side of an embodiment of the invention.

### DETAILED DESCRIPTION OF THE INVENTION

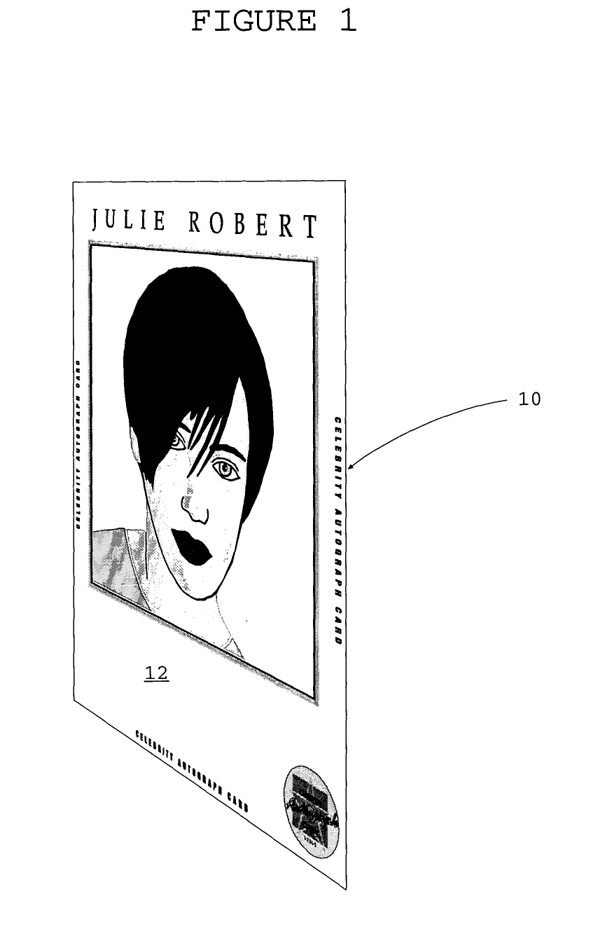

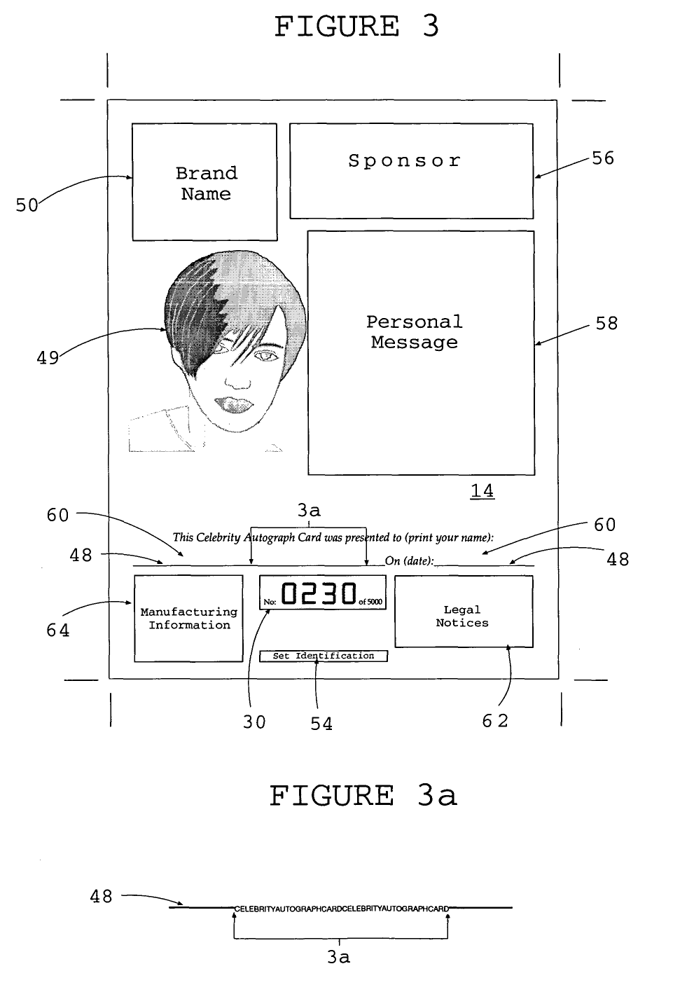

As shown in FIGS. 1 and 3, an autograph card 10 contains a front side 12 and a back side 14. The inventors currently prefer to use autograph cards made from cardstock material with security features printed on or affixed to the cardstock material by a variety of means. However, the autograph card can be comprised of any other material besides cardstock, such as any paper material, various plasticized materials, nylon, or any other material that will allow the security features to be printed on or affixed to the material.

The shape of the autograph card may be any imagined shape (square, rectangular, circular, diamond, etc.). It is believed the most typical dimensions used in the preferred embodiment will be somewhere between 80 mm to 210 mm in width to 80 mm to 300 mm in height in either a square or rectangular shape. Likewise, the thickness may be varied to suit the requirements of the celebrity, or for any reason. The inventors currently prefer using a card thickness somewhere between 0.001 mm to 2 mm.

The autograph card 10 may use a limitless variety of fonts, type, type styles, type designs, type sizes, type colors, colors, designs, printing methods, technologies, inks, or materials. Cards 10 will come in many different visual embodiments because the features on autograph cards 10 will change for each individual celebrity.

Cards 10 will contain one or more security features. Any or all of these security features may be used on cards 10. These security features are methods that make exact duplication difficult, and make copies easier to detect. In addition, the security features can significantly increase the cost of making unauthorized copies. The security features on autograph card 10 may be changed or upgraded to stay current with new or improved methods of security that may be introduced into the marketplace at any given time.

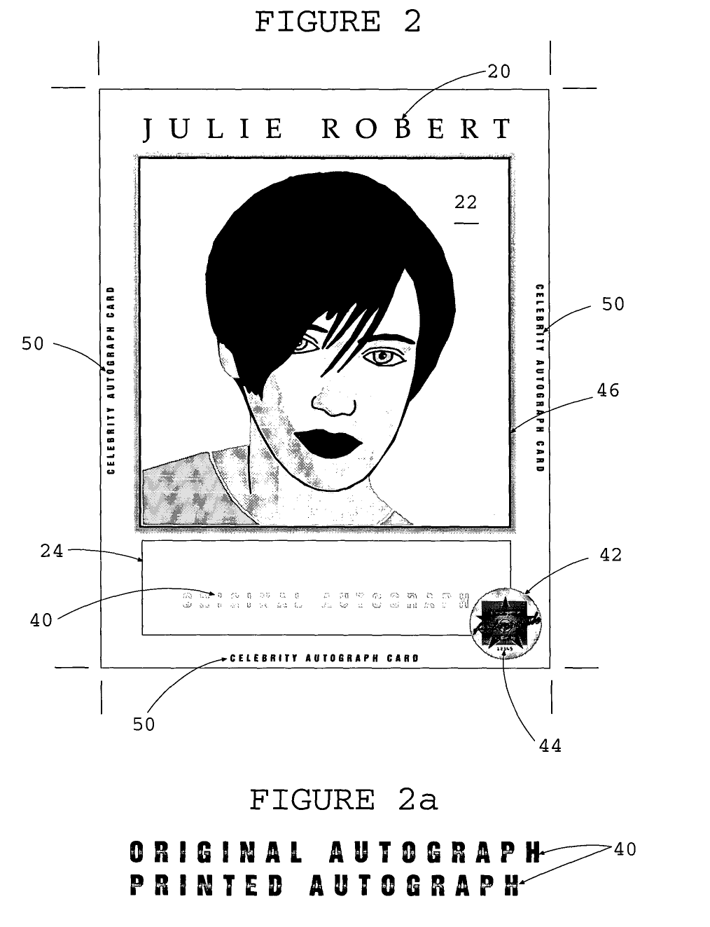

One security feature is hologram 42, as shown in FIG. 2. Hologram 42 may be placed in any location on either front side 12 or back side 14 of card 10. In the preferred embodiment the hologram 42 will be on the front side 12 in the lower right corner as indicated in FIG. 2.

In the preferred embodiment, hologram 42 is two-level, and contains 60 to 75 lines per inch. Hologram 42 is adhered to card 10 with permanent adhesive, making it difficult to remove hologram 42 without damaging card 10. Hologram 42 may have any design or shape.

Another security feature is a miniature design 44. Miniature design 44 may be any number or design printed behind hologram 42. Miniature design 44 is very small, and will require magnification to view miniature design 44. In the preferred embodiment, miniature design 44 will be a specific number assigned to a specific celebrity.

Another security feature is the use of gradated dot pattern printing 40. In the preferred embodiment, gradated dot printing will be from 100% down to 10% and then back up to 100%. However, any gradation pattern may be used. Gradated dot printing 40 will be printed in a very light type. Therefore, gradated dot printing 40 should not affect the aesthetic value of any celebrity autograph that is on top of the dot printing 40.

The inventors envision that gradated dot pattern printing 40 will be used as shown in FIGS. 2 and 2a, to show whether the card is an original or machine printed signature card. As shown in FIGS. 2 and 2a, the inventors envision that the words “ORIGINAL AUTOGRAPH” will be printed if the autograph is intended to be a celebrity's personally signed original handwritten autograph. The inventors further envision that the words “PRINTED AUTOGRAPH” will be printed if the autograph is a celebrity's official autograph created by professional mechanical means. The use of the terms “ORIGINAL AUTOGRAPH” and “PRINTED AUTOGRAPH” are for purposes of illustration only. The gradated dot pattern printing 40 may be used for any words or phrases in any location on card 10.

Gradated dot printing 40 will prevent or discourage others from making unauthorized duplications of autograph card 10. In addition gradated dot printing 40 will make it easier to detect unauthorized duplications of cards 10. As needed, the gradated dot printing 40 may be changed or upgraded to stay current with new or improved methods of security that may be introduced into the marketplace at any given time.

Another security features, as shown in FIG. 2, is gradated drop shadow printing 46. In the preferred embodiment, the gradated drop shadow printing is a 300-line drop shadow, beginning with a 100% dot pattern and gradating down to 0%. In the preferred embodiment, the gradated drop shadow printing 46 will form a frame or outline around the celebrity depiction 22.

Another security feature, as shown in FIGS. 3 and 3a, is security type lines 48. Security type lines 48 appear to be a solid line. They are, in fact, comprised of repeated words or phrases in 1-point type, without any spaces between the words (see FIG. 3a). The repeated word or phrase is visible only with magnification. Any attempt to copy or duplicate the card will result in a blurring of security type 48, and no phrase or words will be visible upon magnification. Security type lines 48 may be used for any line on cards 10. FIG. 3 shows the security type lines 48 as part of a fill-in-the blank section 60. However, security type lines 48 may be used at this location, or any other location on cards 10.

Another security features as shown in FIG. 3, is a light watermark or a very lightened depiction of a celebrity 49. This light watermark or depiction 49 would create an additional difficulty in copying cards 10 for a would-be forger.

Every card 10 will contain a unique tracking number 30, as shown in FIG. 3. Each and every card 10 will be individually and consecutively numbered. The inventors envision that the celebrity will request a set of cards 10. The number of cards printed in a set will vary according to the needs of the celebrity. For example, as illustrated in FIG. 3, the celebrity requested a set of 5000 cards. If an autograph card is the 230^{th} card in a set of 5000 cards, that card and only that card will be tracked and identified as number 0230 of a set of 5000. The next card in the set will be identified and tracked as number 0231 of a set of 5000. The very last card in the entire set will be identified and tracked as number 5000 of a set of 5000.

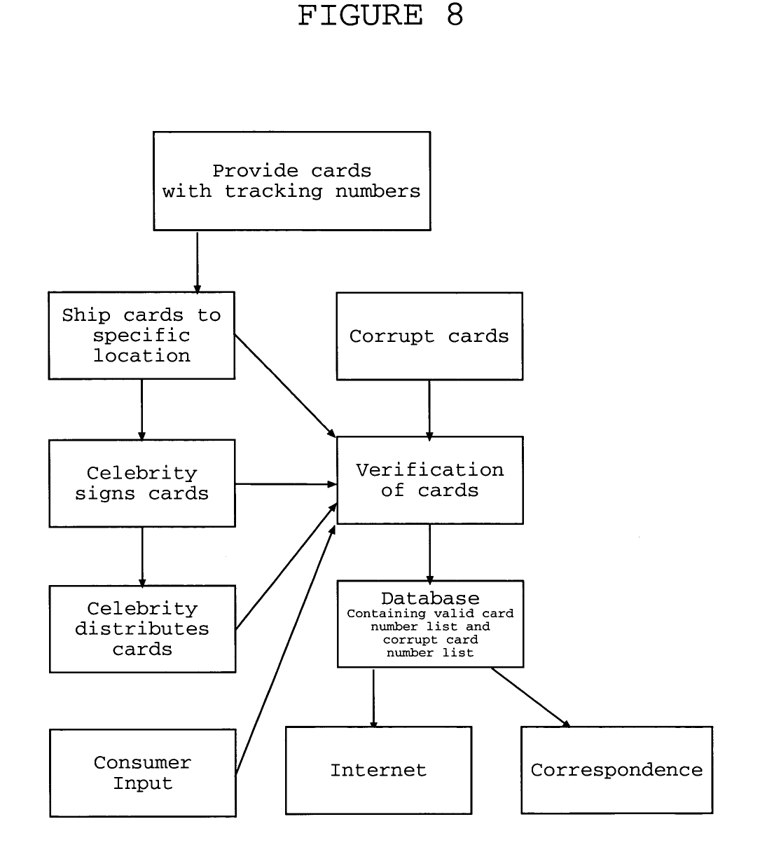

Unique tracking number 30 is part of the tracking and verification system shown in FIG. 8. The verification provider will keep track of all cards 10 that are manufactured.

A celebrity or his or her authorized representative will place an order for a set of cards with the verification provider. Each autograph card will be manufactured with a unique tracking number 30 and at least one security feature, described above. The celebrity or representative will provide a specific location to which the autograph cards 10 will be delivered. Cards 10 containing unique tracking numbers 30 will be delivered only to that specific location.

The verification provider will retain a record of the celebrity that ordered the cards 10, the unique tracking number 30, and the specific location to which cards 10 were delivered. The verification provider will keep a list of the unique tracking numbers 30 of all cards 10 that are delivered to the celebrity. The verification provider will determine if all cards 10 with tracking numbers 30 were received by the celebrity or celebrity representative.

The verification provider will determine if any cards 10 were not received at the specific location. The verification provider will maintain a corrupt card list containing the unique tracking numbers 30 of any cards 10 that, for any reason, are not received at the specific location. The corrupt card list will also contain the unique tracking numbers 30 of any cards 10 that, for any reason, are misplaced after arriving at the specific location. The corrupt card list will contain the unique tracking numbers 30 of all cards 10 that have, for whatever reason, fallen out of the verification system.

The verification provider will maintain a database containing the valid card list and corrupt card list. These lists will identify cards 10 by tracking numbers 30. The lists will not contain personal consumer information. The inventors envision that this database will be available via a web site on the Internet. A consumer can access the web site and obtain information regarding whether a card 10 with a unique tracking number 30 is on the valid card list or the corrupt card list. Alternatively, the consumer may access the database by sending correspondence requesting verification of a card 10 bearing a unique tracking number 30 to the verification provider. The verification provider will then access the database and determine if card 10 bearing a unique tracking number is in the valid card list or the corrupt card list.

After cards 10 are received at the specific location, the celebrity may sign the cards at his or her convenience. The celebrity may chose to sign the cards 10 at home and later distribute the signed cards to fans. Alternatively, the celebrity may bring unsigned cards to events and sign the cards in the presence of fans requesting an autograph. Or, the celebrity may sign the cards at any time or place, and in any manner, the celebrity deems appropriate. If any cards are lost or destroyed while in the celebrity's possession, the celebrity or his or her representative may contact the verification provider to provide the tracking numbers 30 of cards 10. These tracking numbers 30 will be added to the corrupt card list.

After a consumer receives a signed card 10, the consumer may contact the verification provider and provide details concerning the consumer's ownership of the card 10. Although not mandatory, a consumer may wish to provide this consumer input to the verification provider. The consumer input would provide additional information of the cards 10 that will allow the cards 10 to be followed after the celebrity distributes cards 10. The veracity of the consumer information cannot be guaranteed. For example, the consumer may contact the verification provider and state that the consumer received card 10 with tracking number 30 from the celebrity at a specific time and location. If the consumer later sells or transfers this card, the consumer can provide this consumer input to the verification provider. The specific card 10 will thereby remain in the tracking and verification system.

As shown by FIG. 2, the cards 10 may also contain a celebrity name 20, a depiction of the celebrity 22, a space for the celebrity autograph 24. The inventor currently envisions having the name 20, depiction 22, and space 24 on front side 12 of the card 10. However, these elements may be arranged in any manner.

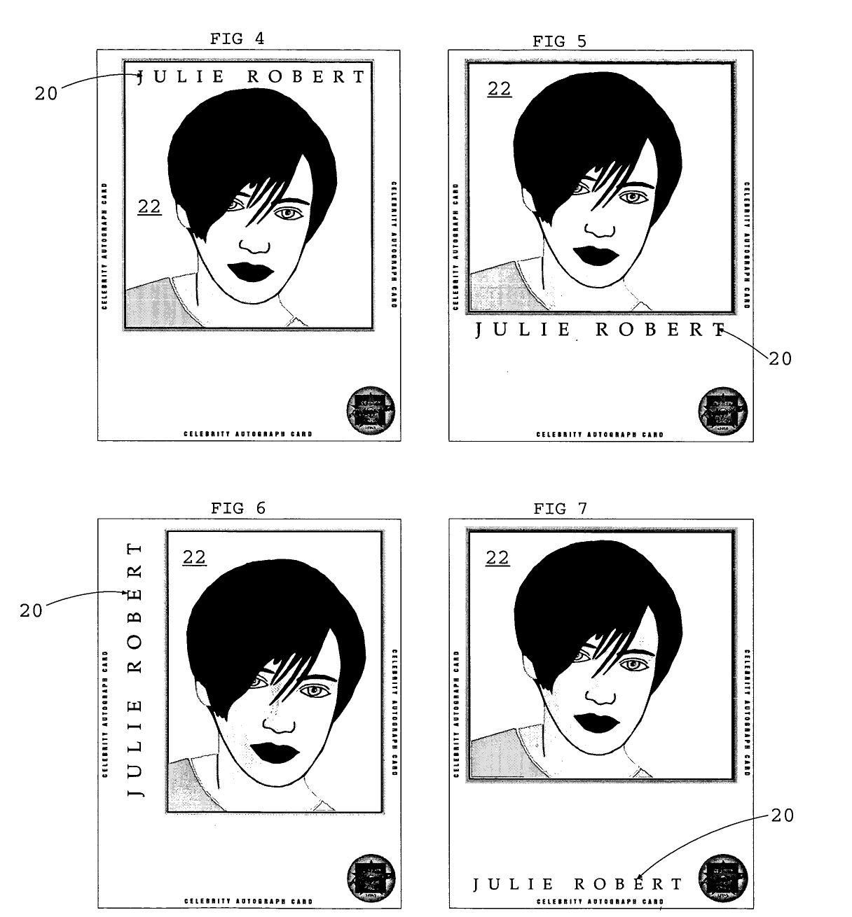

The celebrity name 20 may be in any font, color or design. The celebrity name 20 can be, depending upon the individual celebrity, either a birth name, a legal name, a stage name, a pseudonym, a symbol. The inventors envision that the typical placement of celebrity name 20 will be above the depiction 22, as shown in FIGS. 1 and 2. However, the specific placement of the celebrity name 20 will not be restricted to the placement illustrated. Alternative manners of placement of a celebrity's name may include, but are not limited to, the following possibilities as illustrated in FIGS. 4, 5, 6 and 7. FIG. 4 shows the celebrity name 20 placed on celebrity depiction 22. FIG. 5 shows celebrity name 20 placed below celebrity depiction 22. FIG. 6 shows celebrity name 20 placed along the side (either left or right) of celebrity depiction 22. FIG. 7 shows celebrity name 20 placed at the bottom of the autograph card 10.

Celebrity depiction 22 may be any depiction chosen by the celebrity. For example, the depiction 22 could be a black and white, or color photographic image of the celebrity either in whole or in part, a CD cover, a video box cover, a DVD cover, a movie poster or advertisement, a drawing, any form or style of artistic rendering that depicts a celebrity's likeness and/or a caricature of a celebrity, either in whole or in part, any image chosen by the celebrity, or any other image.

Although depiction 22 is shown with a rectangular or square shape, any shape may be used for depiction 22. The size, style, manner of placement, style of edges and borders of the depiction 22 may vary. For example, depiction 22 may be circular, triangular, or any other shape.

Cards 10 will also contain a space 24 for the celebrity autograph. Space 24 may be an open, clear space, as shown in FIG. 2. However, it is not necessary to have a dedicated area for the autograph. For example, celebrity depiction 22 may take up most of the face of the card, and the celebrity may wish to sign on top of depiction 22. Space 24 may be a location on top of depiction 22, on back face 14, or any other location on card 10. Space 24 is large enough and suitable enough for a handwritten autograph. The celebrity may either personally sign their autograph, or have their official autograph created by professional mechanical means in this space.

Cards 10 contain additional optional features. One optional feature is the brand name 50 of the autograph card. Brand name 50 may appear, any number of times, in any variety of ways, positions or placements. In FIG. 2, the brand name 50 is stated as “Celebrity Autograph Card”. This brand name 50 is used only as an example, and not as a limitation.

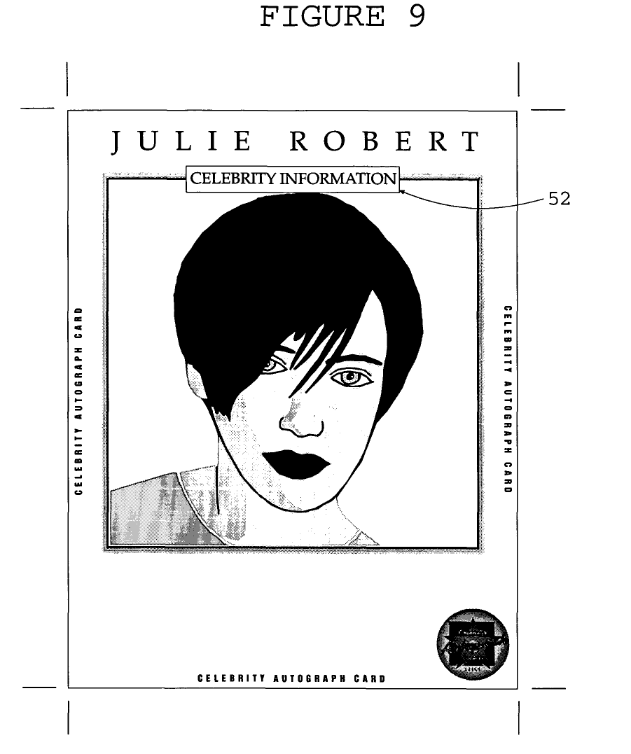

Another optional feature as shown in FIG. 9 is the celebrity information 52. The celebrity information 52 may state any information the celebrity wishes, for example, the celebrity's occupation, title, a professional athlete's team's name, an athlete's position on a team, a beauty pageant winner's title, the name of a radio show or radio station, or other identifying information. The celebrity information 52 may appear at any location, and in any design on cards 10.

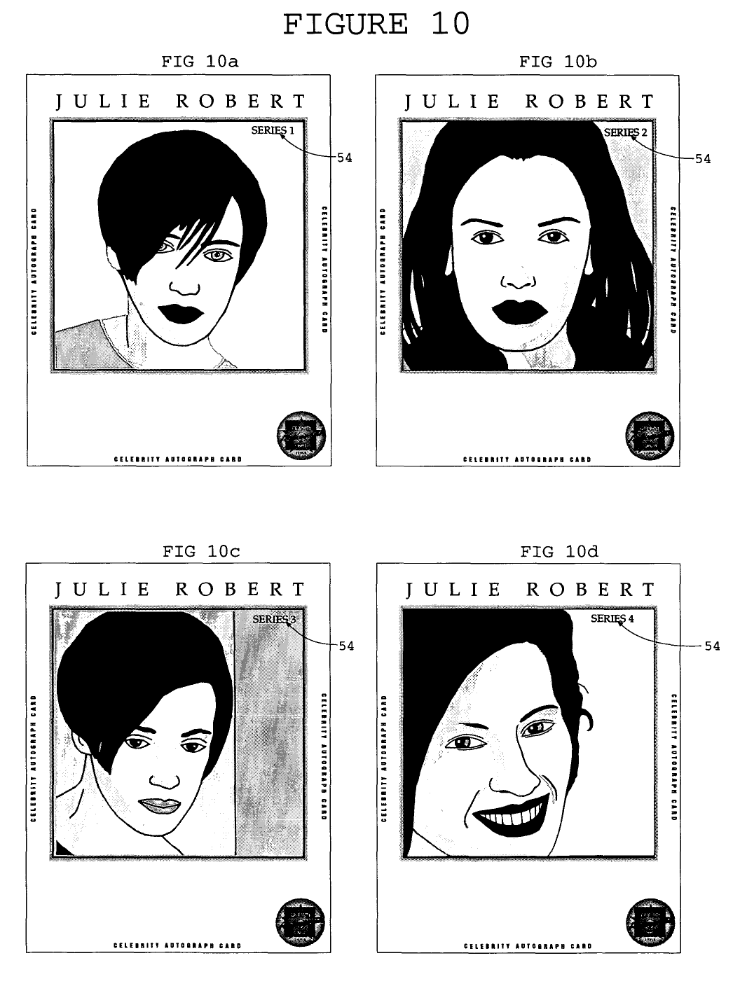

Another optional feature as shown in FIGS. 10a, 10b, 10c and 10d is a set or series number 54. The set number 54 identifies different sets of autograph cards 10. A celebrity may, over the course of time, wish to have different sets or versions of the autograph card 10. These different sets of card of the same celebrity may each have different depictions 22, or may have other design changes. To distinguish the different sets, the set number 54 may appear in print in any location, and in any design on cards 10.

Another optional features as shown in FIG. 3 is an advertisement or sponsor space 56. Advertisers or sponsors may wish to pay to appear on the card, and thereby to offset the cost of printing the card. Advertising space 56 will provide businesses and non-profit organizations with a unique advertising opportunity that currently does not exist. Advertising or sponsor space 56 may appear on either front side 12 or back side 14 of card 10. Advertising or sponsor space 56 may have any design imaginable.

Another optional feature as shown in FIG. 3 is a celebrity's personal message 58. The celebrity may use this space to create a pre-printed message on the cards 10, or to create an individual message to a fan.

Another optional feature as shown in FIG. 3 is a fill-in-the blank section 60. The inventors envision that the consumer will use the fill-in-the blank section 60 to identify who received the card, and when and where the card was received, or any other information as may be required.

Other optional features as shown in FIG. 3 are legal notices 62, manufacturing information 64, and set identification 54.

Although the present invention has been described in terms of various embodiments in regards to the placement and style of mandatory features and numerous possible optional features, it is not intended that the invention be limited to these embodiments. The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

1. A method for verifying and authenticating autograph cards comprising:
(a) obtaining one or more autograph cards where each card contains a unique tracking number and at least one security feature wherein the security feature is a hologram, security line type, gradated dot pattern printing, gradated drop shadow printing, a miniature design, or a watermark;
(b) delivering the cards to a specific location;
(c) retaining a record of the unique tracking numbers and the specific location where the cards containing the unique tracking numbers were shipped;
(d) determining which cards containing the unique tracking numbers arrived at the specific location;
(e) maintaining a database containing
(i) a corrupt card list; and
(ii) a valid card list.

2. The process of claim 1 wherein the database contains consumer input and said consumer input is used to update the corrupt card list and the valid card list.

3. The process of claim 2 wherein the consumer input consists of information provided by a consumer regarding the tracking number, and when and where the consumer received the card.

4. The process of claim 2 wherein the consumer input consists of information provided by the consumer regarding the tracking number, and when and where the consumer sold or transferred the card.

5. The process of claim 1 wherein after the cards arrive at the specific location an individual signs each autograph card at his or her convenience and distributes the signed autograph cards at his or her convenience.

6. The process of claim 5 wherein the database contains the tracking numbers of any cards that are lost or destroyed while in the individual's possession.

7-12. (Cancelled.)

13. The process of claim 1 wherein each card has a plurality of security features.

14. The process of claim 1 wherein a verification provider maintains the database.

15. The process of claim 14 wherein the verification provider maintains a web site and said web site contains the database.

16. The process of claim 15 wherein a consumer may access the database through the web site.

17. The process of claim 14 wherein a consumer may access the database by sending correspondence to the verification provider.
